(19) United States
(12) Patent Application Publication
(10) Pub. No.: US 2011/0056102 A1
(43) Pub. Date: Mar. 10, 2011

(54) FRAME ASSEMBLY FOR DISPLAYING INDICIA AND REFLECTING AN IMAGE

(75) Inventors: Brian P. Reid, Mooresville, NC (US); Jim M. Sweeney, Charlotte, NC (US)

(73) Assignee: Luxury Tech Holdings, LLC, Huntersville, NC (US)

(21) Appl. No.: 12/698,206

(22) Filed: Feb. 2, 2010

Related U.S. Application Data
(63) Continuation-in-part of application No. 12/555,331, filed on Sep. 8, 2009.

(51) Int. Cl. G09F 13/12

(52) U.S. Cl. 40/219

(57) ABSTRACT

The invention relates to a frame assembly for displaying a plurality of indicia and reflecting an image. The frame assembly comprises a display unit for displaying indicia, an enclosure for supporting the display unit, a mirror supported by the enclosure, a sensor supported by the enclosure, a mass storage device for storing the indicia to be displayed on the display unit, a central processing unit for processing the indicia, a signaling system for switching the frame assembly between a first and second mode of operation, a controller in communication with the sensor and central processing unit, and a power supply display unit. The frame assembly in a first mode displays desired indicia through the mirror and, upon the sensor detecting an object at a desired distance, in a second mode functions as a mirror to reflect an image.

### CROSS-REFERENCE TO PRIORITY APPLICATION

This application is a continuation-in-part of U.S. patent application Ser. No. 12/555,331 filed Sep. 8, 2009, in the U.S. Patent and Trademark Office, and claims priority to the earlier application. This application incorporates the earlier application by reference in its entirety.

### BACKGROUND OF THE INVENTION

The invention relates to a frame assembly for displaying a plurality of indicia and reflecting an image, and more specifically, to a frame assembly having a frame supporting at least one light source, a sheet member bearing indicia positioned adjacent to the light source, a film or substrate bearing the indicia and releasably secured to the sheet member, a mirror positioned adjacent to the sheet member and light source, and a sensor, wherein the frame assembly in a first mode displays desired indicia through the mirror and in a second mode functions as a mirror to reflect an image. As configured, the first mode permits the light source to project light through the sheet member and mirror thereby displaying the indicia on the sheet member via backlighting. In a second mode, the sensor detects the presence of an object or individual in front of the frame assembly and deactivates the light source thereby permitting the mirror to serve a conventional purpose (i.e., reflecting an image of an object in front of the mirror).

In one embodiment depicted in FIG. 1, the invention relates to a display unit for displaying the plurality of indicia, an enclosure for supporting the display unit, a mirror supported by the enclosure, a sensor supported by the enclosure, a mass storage device for storing the indicia to be displayed on the display unit, a central processing unit for processing the indicia, a signaling system for switching the frame assembly between the first and second mode of operation, a controller in communication with the sensor and central processing unit, and a power supply. Advantageously, the display unit may be operated remotely via a land line or wireless network to upload or download various indicia, and control the operations of the display unit.

In this embodiment, the first mode permits indicia to be displayed on the display unit. In a second mode, the sensor detects the presence of an object or individual in front of the frame assembly, and communicates with the controller to cause the display unit to display black pixels (i.e., no image), thereby permitting the mirror to serve a conventional purpose (i.e., reflecting an image of an object in front of the mirror).

The presence of mirrors in multiple locations (e.g., washrooms, dressing rooms, hotel rooms, etc.) provides an ideal opportunity to display any number of public service announcements, advertisements, or news stories. In conventional uses, mirrors serve a reflecting purpose. In other words, individuals use mirrors during washing, grooming, shopping, and dressing. In locations where announcements or advertisements are co-located with mirrors (e.g., restaurant bathrooms), the announcements and mirrors require separate wall space. As a result, wall space becomes cluttered and unattractive when bearing mirrors, flyers, advertisements, and various listings.

### SUMMARY OF THE INVENTION

The frame assembly displays any number of indicia in a first mode and reflects an image in a second mode. The frame assembly comprises in one embodiment a frame, at least one light source supported by the frame, a sheet member supported by the frame, a substrate bearing indicia releasably secured to the sheet member, a mirror supported by the frame, and a sensor supported by the frame. The frame may be positioned on a wall, shelf, or any suitable surface. The light source may be secured within or on the frame. The light source of the frame assembly may be powered by an external power source, a battery, or any variety of power cells. The sheet member is removably secured to the frame adjacent to the light source. The mirror is removably secured to the frame adjacent to the sheet member and light source. The sensor is secured to the frame in such a manner as to permit the beam or signal emanating from the sensor to pass through openings in the sheet member and mirror, and optionally the substrate.

In another embodiment, the invention relates to a display unit for displaying the plurality of indicia, an enclosure for supporting the display unit, a mirror supported by the enclosure and positioned substantially adjacent to display panel, a sensor supported by at least a portion of the enclosure, a mass storage device for storing the indicia to be displayed on the display unit, a central processing unit for processing the indicia, a signaling system for switching the frame assembly between the first and second mode of operation, a controller in communication with the sensor and central processing unit, and a power supply.

Advantageously, the inventive frame assembly combines the functions of displaying indicia such as advertisements or announcements, and reflecting an image of, for example, an individual. Further, the frame assembly provides a means to display a plurality of indicia in a single location. Moreover, the invention facilitates the replacement of indicia in an efficient manner.

### BRIEF DESCRIPTION OF THE DRAWINGS

The foregoing and other objects and advantages of the invention and the manner in which the same are accomplished will become clearer based on the following detailed description taken in conjunction with the accompanying drawings in which:

FIG. 1 is an exploded perspective view of one embodiment of the frame assembly of the invention;

FIG. 2A is a perspective view of one embodiment of the frame assembly of FIG. 1 depicting the frame assembly in a first or display mode at distance x;

FIG. 2B is a perspective view of one embodiment of the frame assembly of FIG. 1 depicting the frame assembly in a second or mirror mode at distance y;

FIG. 3 is a partial enlarged perspective view of one embodiment of the frame assembly of FIG. 1 depicting the sensor and display unit; and

FIG. 4 is a perspective view of another embodiment of the frame assembly; and

FIG. 5 is a perspective view of another embodiment of the frame assembly.

### DETAILED DESCRIPTION OF THE INVENTION

The present invention will now be described more fully hereinafter with reference to the accompanying drawings, in which a preferred embodiment of the invention is shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

The frame assembly 10 for displaying a plurality of indicia 15 (e.g., a flag) and reflecting an image (e.g., individual) comprises in one embodiment a frame 11, at least one light source 12 supported by the frame, a sheet member 13 bearing indicia and supported by the frame when positioned substantially adjacent to the light source, a substrate 14 bearing the indicia and releasably secured to the sheet member, a mirror 20 supported by the frame when positioned substantially adjacent to the sheet member and the light source, and a sensor 21 supported by the frame. As configured, the frame assembly 10 functions to display the indicia 15 through the mirror 20 in a first mode of operation (i.e., display mode) and functions as a mirror in a second mode of operation (i.e., mirror mode).

The invention provides a frame 11 for housing and supporting remaining elements of the frame assembly 10. The frame 11 may provide an opening 22 to permit an electrical cord 23 to travel from the light source 12 to a power outlet. In this embodiment, the light source 12 is powered by electricity provided by an external source. Alternatively, the light source may be powered by a battery or power cell and thus, no opening for the power cord is required.

The light source 12 may include any number of light bulbs 24 or light emitting devices (LEDs) 25. For example, the light source 12 may include one or more fluorescent lights or bulbs, one or more light emitting diodes (LEDs), one or more halogen lights, or one or more xenon lights. In one embodiment, the light source 12 may be one or more fluorescent bulbs 24 of sufficient strength to project light through the mirror. In the embodiment relying upon fluorescent bulbs 24 to provide backlighting, the bulbs are individually replaceable for ease of replacement.

In another embodiment, the light source 12 may include a plurality of light emitting diodes (LEDs) 25 of sufficient strength to project light through the sheet member 13, substrate 14 bearing the indicia 15, and the mirror 20. In this embodiment, LEDs 25 provide backlighting and illumination of the indicia 15 on the substrate 14 supported by the sheet member 13. In one embodiment, the LEDs 25 are manipulated on-site to change the indicia 15 or, more advantageously, could be operated remotely via a land line or wireless network.

In an alternative embodiment, the light source 12 may be a plurality of LEDs 25 arranged in a specific pattern and capable of depicting desired indicia. This embodiment lacks a sheet member 13 or substrate 14 bearing indicia 15. In yet another embodiment, a plurality of independently activated LEDs 25 may be relied upon to depict any number of desired indicia.

The sheet member 13 is transparent and may bear any number of reusable and removable substrates 14 carrying indicia 15. In one embodiment the sheet member 13 is releasably secured to the frame 11 substantially adjacent to the light source 12. The sheet member 13 may be secured to the frame 11 with any number of releasable fasteners or adhesives. The sheet member 13 may be formed from any number of materials capable of providing transparency. For example, the sheet member 13 may be formed from acrylic that is extruded as a sheet, or a polycarbonate resin thermoplastic.

The sheet member 13 supports the reusable, removable substrate 14 bearing indicia. Accordingly, the substrate 14 may be removed and replaced with any number of substrates bearing any number of indicia 15. The substrate 14 is of sufficient transparency to permit light from the light source 12 to pass there through and illuminate indicia on the substrate.

The mirror 20 reflects an image and is removably secured to the frame 11. In one embodiment the mirror 20 is removably secured to the sheet member 13 and frame 11. The mirror 20 is reflective on one side and transparent on another side. For example, the mirror 20 may be a security mirror of the type used for surveillance of an area. The mirror 20 is secured to the frame 11 substantially adjacent to the sheet member 13. The mirror 20 may be secured to the frame 11 and sheet member 13 with any number of releasable fasteners or adhesives.

In one embodiment, the mirror 20 includes one side painted with reflective material that permits light from the light source 12 approaching from an opposite side to pass through the mirror. In another embodiment, the mirror 20 includes a laminated reflective film adhered to one side that permits light approaching from an opposite side to pass through the mirror.

The sensor 21 is supported by the frame 11 and is adjustable such that it detects the presence of an object at any number of desired distances x, y. The sensor 21 communicates with the light source 12 to activate and deactivate the light source, and alternate between the first and second modes of the assembly. The sensor 21 projects a signal or beam 30 to detect the presence of an object. Upon sensing an object (e.g., individual), the sensor 21 interrupts power to the light source 12, and the mirror 20 reflects an image of, for example, the individual standing in front of the mirror. The sensor 21 is adjustable to detect objects within, for example, one to four feet in its vicinity. For example, in the first mode, the signal 30 of the sensor 21 is adjusted such that its range for detecting an object is beyond distance x, and the invention displays the indicia 15 via backlighting provided by the light source. In the second or mirror mode, the signal 30 identifies an object at distance y, interrupts power to the light source 12, and permits an individual to use the mirror.

The sheet member 13 and the mirror 20 each define at least one opening 31, 32, respectively, through which the signal 30 from the sensor 21 travels. The substrate 14 may also define at least one opening 33 if required. Stated differently, openings 31, 32 are provided in the sheet member 13 and mirror 20 to permit passage of the signal 30 from the sensor 21 in the frame 11, through the sheet member 13, substrate 14 and mirror 20, and into the space adjacent to the frame assembly. Alternatively, sufficient transparency is provided in at least a portion of the sheet member 13 and mirror 20 to permit passage of the signal 30 from the sensor 21 into the space adjacent to the frame assembly 10.

In yet another embodiment, a frame assembly 26 for displaying indicia and reflecting an image comprises a frame 18 defining an opening 27, a display panel 16 (e.g., liquid crystal display (LCD) monitor) supported by the frame 18, a mirror 20 positioned substantially adjacent to the LCD monitor 16, an adhesive sheet 17 having adhesive on both sides (e.g., two-sided tape) for securing the mirror to the frame 18, an interrupt circuit board 19 for operating the frame assembly 26, and a sensor 21 supported by the frame or monitor. This embodiment lacks a sheet member or substrate. The sensor 21 and interrupt circuit board 19 operate to interrupt power to the monitor upon detection of an object at a desired distance. Advantageously, the monitor 16 is capable of displaying any variety of indicia and may be operated remotely.

In particular, this alternative embodiment would permit an individual to remotely change the indicia appearing in the frame assembly for any number of reasons. For example, an individual could alternate images or advertisements depending upon the time of day, weather, or expected crowd. Further, if collecting a fee for providing the advertising space, the individual could remotely remove an advertisement from an individual who did not pay or power off the frame assembly if, for example, a restaurant owner was leasing the frame assembly and failed to pay.

In yet another embodiment, the frame assembly 10 may include a monitor 16 having a reflective screen, eliminating the need for a mirror 20, sheet member 13, and substrate 14.

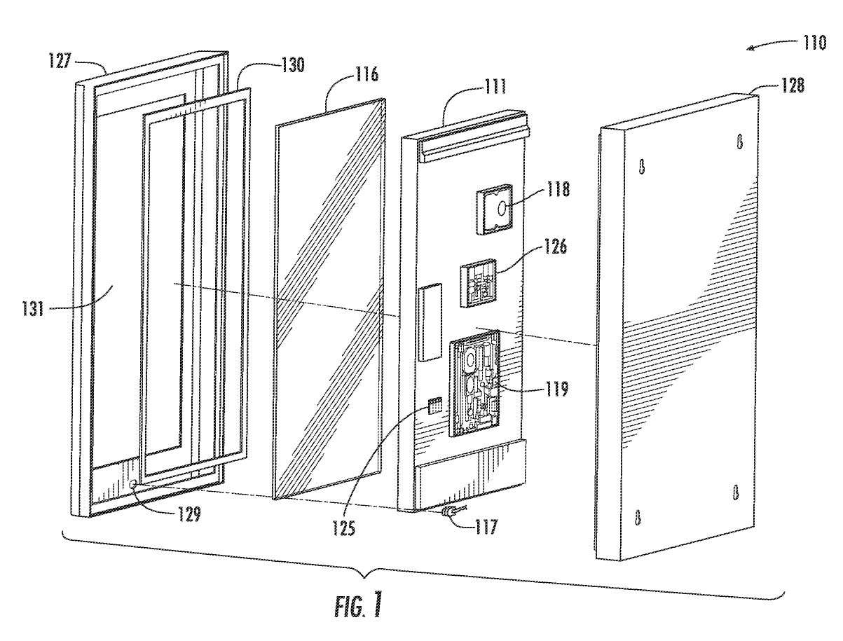

An overall view of yet another embodiment of a frame assembly of the invention is set forth at 110 in the perspective view of FIG. 1. The frame assembly 110 for displaying a plurality of indicia 112 and reflecting an image 113, comprises in this other embodiment a display unit 111 for displaying the plurality of indicia, an enclosure 115 for supporting the display unit, a mirror 116 supported by the enclosure 115 and positioned substantially adjacent to the display unit 111, a sensor 117 supported by at least a portion of the enclosure 115, a mass storage device 118 for storing the indicia 112 to be displayed on the display unit 111, a central processing unit 119 for processing the indicia, a signaling system 120 for switching the frame assembly between the first and second mode of operation, a controller 125 in communication with the sensor 117 and central processing unit 119, and a power supply 126. In this embodiment, the display unit may be a liquid crystal display panel (i.e., LCD).

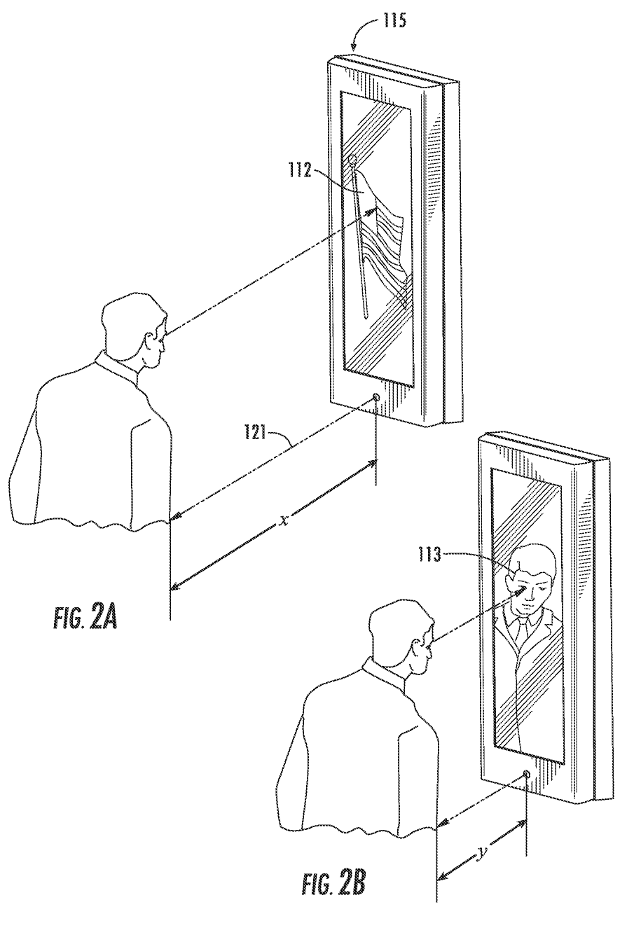

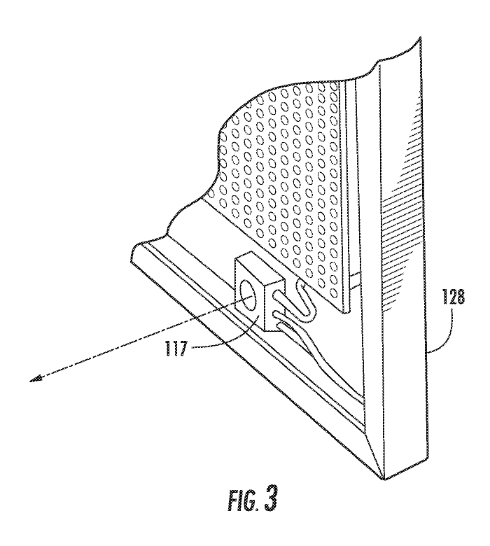

The sensor 117 may be a proximity sensor (e.g., 12 volt DC sensor) for detecting the presence of an individual or object at a desired distance from the assembly and causing the frame assembly to switch between a first and second mode of operation. For example, as shown in FIG. 2A illustrating the first or display mode, the signal of the sensor 117 is adjusted such that its range for detecting an object is beyond distance x, and the invention displays the indicia 112. As shown in FIG. 2B illustrating the second or mirror mode, the signal identifies an object at distance y, affects the operation of the display unit, and permits an individual to use the mirror.

As discussed above, the first mode of operation functions to display the indicia 112 on the display unit 111 and through the mirror 116. In other words, the frame assembly 110 displays desired indicia 112 in the first mode of operation. The indicia 112 may be still images (e.g., photographs), slideshows, videos, auto-stereoscopic images, or any indicia capable of being displayed on a LCD. In one example, the assembly 110 may display an advertisement as discussed above. In the second mode of operation, the frame assembly 110 functions as a mirror.

Advantageously, the frame assembly 110 may be operated remotely via, for example, the World Wide Web, for uploading and downloading data, images, recordings, and the like. The assembly 110 may also be operated remotely for programming, updating, and altering indicia stored on the assembly.

The enclosure 115 comprises a first section 127 and a second section 128, or stated differently, a front section and a rear section. The first section 127 is connected to at least a portion of the second section 128. For example, the first and second sections 127, 128 may be connected with a hinge or by a sliding engagement. Alternatively, the first or front section 127 may be removable to permit access to the remaining elements of the invention. The first and second sections 127, 128 may be secured to one another with, for example, a lock, thereby protecting the assembly from tampering by unauthorized individuals.

The frame assembly 110, and in particular the enclosure 115, may be mounted on a wall or other surface in a portrait or landscape orientation and securely fastened with the second or rear section 128 flush with the surface. All data and power connections protrude from the rear or second section 128 of the enclosure 115 and into a wall surface. Alternatively, conduits may be incorporated into the assembly 110 and connected to the top, bottom, or sides of the enclosure 115 if electrical connections cannot be run through a wall surface.

The first or front section 127 of the enclosure 115 may be formed from stainless steel or carbon steel that has been powdered coated with a corrosion resistant paint. The second or rear section 128 of the enclosure may also be constructed of carbon steel that has been coated with a corrosive inhibiting paint. It will be understood that the enclosure 115 may be formed from any other type of material sufficient to protect the remaining elements of the invention.

As depicted in FIGS. 2A and 2B the enclosure defines an opening 129 through which a signal 121 from the sensor 117 travels into the space adjacent to the frame assembly 110.

The mirror 116 may be formed of two-way mirror glass and may be affixed to the first or front section 127 of the enclosure 115. It will be understood that a single mirror and multiple display units may be utilized. For example, the invention could be configured such that multiple display units 111 are secured to a wall surface, and a single mirror 116 could cover the multiple display units to provide the appearance of one mirror with multiple displays bearing multiple indicia displayed through the mirror in the first mode of operation.

In one embodiment depicted in FIG. 1, the mirror is affixed to the first section 127 of the enclosure 115 with an adhesive sheet 130 positioned between a portion of the enclosure 115 and the mirror 116. For example, the adhesive sheet 130 may be waterproof two-sided tape covering the full perimeter area of an opening 131 defined by the first section 127. It will be understood that any number of means for securing the mirror to the enclosure may be incorporated into the invention.

Advantageously, the frame assembly 110, and specifically the sensor 117 and controller 125, operates to track the number of times the frame assembly switches between the first and second mode of operation. This permits the frame assembly 110 to track the number of hits or viewings that occur during any period of time. For example, a user may track the number of people that approach the frame assembly 110, view the indicia 112 (e.g., advertisement), and then use the mirror 116. This tracking information may be accessed remotely and provides a near real time rate of viewing to a party who has purchased advertisement space on the frame assembly.

The mass storage device 118 may include a hard disk drive, solid state drive, flash drive, optical drive, or any number of devices for storing data and indicia to be displayed on the display unit. The mass storage device 118 is in communication with the display unit 111 and is accessible via a worldwide network (e.g., World Wide Web) for uploading and downloading data, images, and other indicia.

The central processing unit (CPU) 119 is in communication with the mass storage device and processes the indicia for display. The CPU 119 may include a commercially available or custom designed motherboard or single board computer of sufficient capability to display desired indicia and maintain desired data. The CPU 119 should be of sufficient quality and capability as to permit high resolution images and videos to be displayed on the display unit without interruption. The circuit board of the CPU may include a large area network (LAN) connection or at least provide a connection for a wireless card for data transmission to and from the frame assembly. Advantageously, an internal LAN connection provides the capability of the display unit to display videos on multiple frame assemblies in a sequential format along multiple display units from one external source or one processing source (e.g., a central processing unit, or the World Wide Web. Accordingly, multiple frame assemblies and their respective display units may act as a single display having indicia (e.g., an image) moving from one frame assembly to another.

The frame assembly 110 may also include a signaling system 120 for switching the frame assembly between the first and second mode of operation. The signaling system 120 has at least one signal path (e.g., three as discussed herein) and is in communication with the sensor 117. In one embodiment, the signaling system 120 is a low-voltage differential signaling system or LVDS. The LVDS is a differential signaling system in that it transmits two different voltages that are compared at a receiver. Advantageously, the LVDS combines low power dissipation with high speed.

As discussed in detail below, the signaling system 120 transmits data signals (e.g., synchronizing signal and three color signals red, green, and blue) to the display unit 111 in the first mode of operation upon deactivation of the sensor 117. In other words, the signaling system 120 ensures that indicia 112 are displayed on the display unit 111 in the absence of an individual standing in an area substantially adjacent to the frame assembly. The signaling system 120 applies a zero voltage signal across at least one signal path (e.g., across three color signal paths for red (R), green (G), and blue (B)) of the signaling system to cause the frame assembly 110 to switch to the second mode of operation upon activation of the sensor 117. Stated differently, application of a zero voltage across the RGB signal paths ensures that only black pixels appear on the display unit (i.e., the absence of an image.)

The LVDS forms a part of a digital display interrupt circuit 132 present in one embodiment of the invention. In operation, the display unit 111 (e.g., LCD panel) is illuminated via the LVDS system that allows data to be sent from the processor 119 to the display unit 111 and that combines low power dissipation with high speed. The LVDS system transmits all data required to display digital images to the display unit utilizing a 40-pin connector and cable. Among the numerous data signals transferred by the LVDS are the synchronizing signal and the three color signals red (R), green (G), and blue (B) (i.e., RGB signals).

The amount of voltage across each RGB signal path determines the intensity of each color appearing on the display unit 111. By applying a zero voltage signal across all three signal paths (red, green and blue), a black screen appears on the LCD panel. In order to create a zero voltage RGB signal without interrupting the synchronizing signal, a relay—either mechanical or software encoded—is required to redirect the RGB signals traveling from the processor such that the signals do not reach the LCD panel. As a result, only black pixels, and hence no image, appear on the display unit or LCD panel 111.

The mechanical version of the interrupt circuit includes an interrupt circuit 132 in communication with the sensor 117 and display unit 111. In this embodiment, the interrupt circuit 132 switches the frame assembly 110 between the first and second mode of operation. In particular, the mechanical version of this interrupt circuit 132 utilizes in one embodiment three electrically operated coil relays to divert the voltage signals to a 75-Ohm header to prevent the processor from detecting an open circuit. In this configuration, current remains flowing over the three coil relays forming the circuit. The coil relays are actuated through a voltage or power source supplied when the proximity sensor 117 is activated and the frame assembly 110 operates in the second mode of operation as a mirror 116 (i.e., when an individual stands within a desired distance of the frame assembly). When the sensor 117 is released or deactivated the voltage travels along its original signal path to the display unit or panel 111 and the display panel displays indicia 112 in the first mode of operation.

The software version of the signaling system 120 is incorporated into the central processing unit 119. Specifically, the processor 119 is encoded to refrain from sending voltage to the display unit 111 along the RGB signal paths. The software is signaled on and off by an input signal from the sensor connected to an input/output board of the controller 125.

The controller 125 is in communication with the sensor 117 and the CPU 119, and directs the CPU to switch the frame assembly between the first and second mode of operation. Specifically, the controller 125 may include a commercially available or custom designed input/outboard (I/O) board that is positioned operationally between the sensor 117 and the CPU 119. In the embodiment incorporating the software version of the interrupt circuit (i.e., signaling system) to switch the indicia (e.g., digital image) on and off between the first and second mode of operation, the I/O board converts a voltage signal from the sensor into a data string that is read by the CPU 119.

The invention further includes a power supply 126 for providing power to elements of the frame assembly 110 requiring electricity.

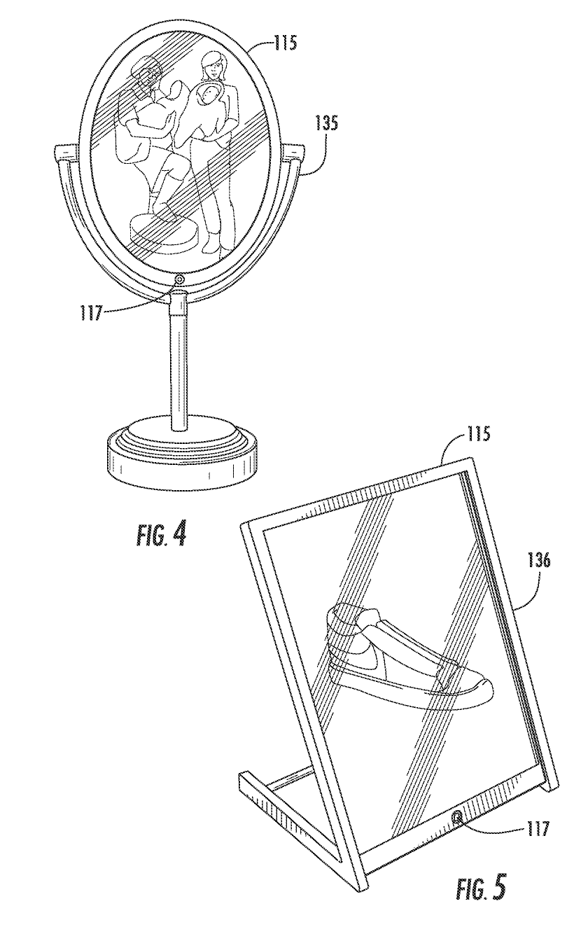

As shown in FIG. 4, another embodiment of the invention comprises a frame assembly 110 supported by a swivel frame 135 such that the frame assembly may be placed on a countertop. In this embodiment, the frame assembly includes a display unit 111 for displaying indicia 112, an enclosure 115 for supporting the display unit, a mirror 116 supported by the enclosure and positioned substantially adjacent to display panel, a sensor 117 supported by at least a portion of the enclosure, a mass storage device 118 for storing the indicia to be displayed on the display unit, a central processing unit 119 for processing the indicia, a signaling system 120 for switching the frame assembly between the first and second mode of operation, a controller 125 in communication with the sensor and central processing unit, a swivel frame 135, and a power supply 126. The display unit 111 may be a liquid crystal display panel (i.e., LCD).

In yet another embodiment depicted in FIG. 5, the frame assembly 110 may be supported by a frame 136 and placed on a floor surface. This embodiment includes a display unit 111 for displaying indicia 112, an enclosure 115 for supporting the display unit, a mirror 116 supported by the enclosure and positioned substantially adjacent to display panel, a sensor 117 supported by at least a portion of the enclosure, a mass storage device 118 for storing the indicia to be displayed on the display unit, a central processing unit 119 for processing the indicia, a signaling system 120 for switching the frame assembly between the first and second mode of operation, a controller 125 in communication with the sensor and central processing unit, a frame 136 for supporting the enclosure on, for example, a floor, and a power supply 126. The display unit may be a liquid crystal display panel (i.e., LCD).

In the drawings and specification, there have been disclosed typical embodiments on the invention and, although specific terms have been employed, they have been used in a generic and descriptive sense only and not for purposes of limitation, the scope of the invention being set forth in the following claims.

That which is claimed is:

1. A frame assembly for displaying indicia and reflecting an image, said frame assembly comprising:
a display unit for displaying a plurality of indicia;
an enclosure for supporting said display unit;
a mirror supported by said enclosure and positioned substantially adjacent to said display panel, said mirror for reflecting an image; and
a sensor supported by at least a portion of said enclosure, said sensor for detecting the presence of an object at a desired distance and causing said frame assembly to switch between a first and second mode of operation;
wherein said frame assembly in said first mode of operation functions to display said indicia on said display unit and through said mirror; and
wherein said frame assembly in said second mode of operation functions as a mirror.

2. The frame assembly of claim 1 wherein said indicia are images, slideshows, or videos.

3. The assembly of claim 1 wherein said display unit is a liquid crystal display panel.

4. The frame assembly of claim 1 wherein said frame assembly is operated remotely.

5. The frame assembly of claim 1 wherein said enclosure comprises a first section and a second section, said first section connected to at least a portion of said second section.

6. The frame assembly of claim 1 wherein said enclosure defines an opening through which a signal from said sensor travels.

7. The frame assembly of claim 1 wherein said mirror is formed of two-way mirror glass.

8. The frame assembly of claim 1 wherein said frame assembly operates to track the number of times said frame assembly switches between said first and second mode of operation.

9. The frame assembly of claim 1 further comprising an adhesive sheet positioned between a portion of said enclosure and said mirror for securing said mirror to said enclosure.

10. The frame assembly of claim 1 further comprising:
a mass storage device for storing said indicia to be displayed on said display unit, said mass storage device in communication with said display unit; and
a central processing unit for processing said indicia, said central processing unit in communication with said mass storage device.

11. The frame assembly of claim 1 further comprising a signaling system for switching said frame assembly between said first and second mode of operation, said signaling system having at least one signal path and in communication with said sensor.

12. The frame assembly of claim 11 wherein said signaling system transmits data signals to said display unit in said first mode of operation upon deactivation of said sensor.

13. The frame assembly of claim 11 wherein said signaling system applies a zero voltage signal across said at least one signal path of said signaling system to cause said frame assembly to switch to said second mode of operation upon activation of said sensor.

14. The frame assembly of claim 11 wherein said signaling system comprises an interrupt circuit in communication with said sensor and said display unit, said interrupt circuit for switching said frame assembly between said first and second mode of operation.

15. The frame assembly of claim 11 wherein said signaling system is incorporated into said central processing unit.

16. The frame assembly of claim 15 further comprising a controller in communication with said sensor and said central processing unit, said controller for directing said central processing unit to switch said frame assembly between said first and second mode of operation.

17. The frame assembly of claim 1 further comprising a power supply for providing power to said frame assembly.

18. A frame assembly for displaying indicia and reflecting an image, said frame assembly comprising:
a display unit for displaying a plurality of indicia;
an enclosure for supporting said display unit;
a mirror supported by said enclosure and positioned substantially adjacent to said display panel, said mirror for reflecting an image;
a sensor supported by at least a portion of said enclosure, said sensor for detecting the presence of an object at a desired distance and causing said frame assembly to switch between a first and second mode of operation;
a mass storage device for storing said indicia to be displayed on said display unit, said mass storage device in communication with said display unit; and
a controller in communication with said sensor for directing said display unit to switch said frame assembly between a first and second mode of operation;
wherein said frame assembly tracks the number of times said frame assembly switches between a first and second mode of operation.

19. The frame assembly of claim 1 wherein:
said frame assembly in said first mode of operation functions to display said indicia on said display unit and through said mirror; and
wherein said frame assembly in said second mode of operation functions as a mirror.

20. A frame assembly for displaying indicia and reflecting an image, said frame assembly comprising:
a display unit for displaying a plurality of indicia;
an enclosure for supporting said display unit;
a mirror supported by said enclosure and positioned substantially adjacent to said display panel, said mirror for reflecting an image; and
a sensor supported by at least a portion of said enclosure, said sensor for detecting the presence of an object at a desired distance and causing said frame assembly to switch between a first and second mode of operation;
a mass storage device for storing said indicia to be displayed on said display unit, said mass storage device in communication with said display unit;
a central processing unit for processing said indicia, said central processing unit in communication with said mass storage device; and
wherein said frame assembly in said first mode of operation functions to display said indicia on said display unit and through said mirror; and
wherein said frame assembly in said second mode of operation functions as a mirror.
